(19) United States
(12) Patent Application Publication
(10) Pub. No.: US 2019/0300795 A1
(43) Pub. Date: Oct. 3, 2019

(54) Treatment Process for Polluted Oil Sludge

(71) Applicant: Hang REN, Qingdao (CN)

(72) Inventor: Hang REN, Qingdao (CN)

(21) Appl. No.: 15/967,063

(22) Filed: Apr. 30, 2018

(30) Foreign Application Priority Data
Apr. 3, 2018 (CN) 201810292435.6

(51) Int. Cl. C10G 1/04; C10G 17/10; C10G 21/20; C10G 21/28; B01D 45/12; B01D 3/14

(52) U.S. Cl. CPC C10G 1/04; C10G 17/10; C10G 21/20; C10G 2300/1003; B01D 45/12; B01D 3/14; C10G 21/28

(57) ABSTRACT

Treatment systems, agents and processes are described for processing polluted oil sludge into environmentally harmless and reusable resources. The oil sludge is first crushed, mixed with water, stirred, and stratified, then the overflow layer with the oil slick is transferred into oil recovery tank; the remaining mixture of solid and liquid is then subjected to centrifugal solid-liquid separation, the resulting free water is collected for reuse through osmosis, and the remaining solid phase material goes through a secondary oil content reduction treatment, adding water, degradable treatment agent, stirring, and after the system was standing stratified, the upper layer with the oil slick is overflowed and transferred to oil recovery tank; for the mixture from the centrifugation separation and reduction treatment processes, the resulting liquid phase is subjected to oil water separation, the oil phase is transferred into the oil recovery tank, the water phase enters into the wastewater recycling tank for recycle and reuse, the remaining solid phase is treated to become environmentally harmless materials; undergo centrifugal separation again, and the liquid phase is distilled to recover the plant based treatment agent, the remaining oil is transferred to the oil recovery tank, and the excess sludge is dried.

### FIELD OF THE INVENTION

This application relates to the field of petroleum environmental protection, in particular to a harmless oil sludge treatment process to separate and recover useful resources such as crude oil from within the sludge, and render the resulting sludge harmless.

### DISCUSSION AND COMPARISON WITH RELEVANT PRIOR ART

Oil saturated sludge in oil fields is an oil-containing hazardous solid waste generated during oil field development, oil product storage and transportation, and refining and development process. Such oil sludge is characterized by high oil content, high viscosity, fine particle size, and difficulty to dehydrate, among others. The composition of oil sludge is extremely complex. It generally contains large amounts of aged crude oils, waxes, asphaltenes, colloids and suspended solids, bacteria, salts, acidic gases, and small amounts of heavy metal salts such as copper, zinc, chromium, and mercury. At the same time, it can contain odoriferous toxic substances such as benzenes, phenols, anthracene and pyrene. If these substances are not properly treated, direct discharge of the oil sludge will seriously pollute the surrounding soil, water bodies, vegetation, and the atmosphere, thereby deteriorating the ecological environment as a whole.

On the other hand, given that oil sludge in oils fields contain significant amounts of petroleum based substances, metals, and inorganic substances, it is an important resource in terms of oil and gas recovery and metal mineral reuse value. Therefore, it would be wasteful to directly discharge the oil sludge.

Currently, treatment and recycling of oil sludge is still considered a major problem for the oil industry.

Conventional technologies used in China and internationally for treating oil sludge mainly consistent of solvent extraction, rotary pyrolysis, solidification and incineration, solid-liquid separation, microbial degradation, chemical cleaning and landfilling.

Although solvent extraction is thorough and effective, it currently has the disadvantage of lacking a highly efficient, pollution-free, and low safety risk extractant. Second, the problem of operation loss of the extractant has not yet been addressed in a satisfactory manner, resulting in high cost such that it cannot be broadly promoted and used.

The heat treatment method includes incineration, pyrolysis, scorching, etc., wherein the material to be treated is oxidized and decomposed under high temperature conditions, quickly and significantly reducing volume while heat energy generated in the combustion process is reused. This process requires high equipment and operating costs, high consumption of energy from combustion and high consumption of aiding agent. Moreover, the method can easily produce secondary pollutants such as flue gas, thereby increasing processing costs.

Chemical cleaning is usually used in combination with solid-liquid separation, and usually includes of three steps: chemical cleaning, emulsion flocculation and mechanical separation. Chemical cleaning agents have a detrimental effect on the environment and are highly specific and single purposed, and may have lower than expected effect or become even completely ineffective when the treatment object changes.

The microbial degradation method utilizes microorganism metabolism to assimilate and degrade the petroleum hydrocarbons as a carbon source, and finally converts them into CO₂ and H₂O. Here, operating costs are low, but microbial cultures are difficult to develop and have a long operating cycle. Conditions of the soil such as temperature, humidity, and acidity will also affect treatment results. Moreover, sewage oil cannot be recovered, resulting in waste of potential resources, and may easily result in secondary pollution.

Landfilling involves first packaging up the oil sludge, carrying it out to appropriate landfill sites and directly burying it underground. This method has a significant impact on the environment. Once a leak occurs, the surrounding soil and even underground water will likely be polluted.

Among existing technologies, the material obtained after undergoing several rounds of the treatment process as described in Chinese publication CN 107352765 A can only be used for pressing bricks, indicating that the oil content of such material is still higher than 1%, and does not reach the removal levels necessary to render the materials harmless.

The refinery oil sludge disposal system and method disclosed in Chinese publication CN 107500501 A uses high temperature pyrolysis above 400° C. Although the degree of reduction is over 96%, its energy consumption is high, and smoke and other harmful substances are generated during the treatment process, causing secondary threat to the environment.

Chinese publication CN 107381983 A describes an oil sludge treatment agent and its preparation method. Although its treatment effect is good, the preparation of its treatment agents is complex. Also, the types of sludge applicable is narrow in scope, and the processing cycle is more than half a month.

Chinese publication CN 107162360 A describes an efficient oil sludge treatment agent. While its sludge treatment effect is good, it requires outdoor exposure and fermentation for more than 20 days. Moreover, the required operating floor space is large, and the treatment period is long.

Finally, the oil sludge treatment method described in Chinese publication CN 107253810 A can only reduce oil content of the oil sludge to less than 2% after several treatments rounds, thus failing to meet the standards for agricultural soil use.

Therefore, there is an urgent need for a harmful material treatment process that can be effectively utilized at a low temperature, has high efficiency, and has a high removal effect.

### SUMMARY OF THE INVENTION

Treatment processes, assemblies and agents are described for processing polluted oil sludge into environmentally harmless materials and reusable resources. The method mainly comprises the steps (1) pretreatment: oil sludge sent through sludge crusher and sludge sieve; (2) first reduction: pretreated sludge is mixed with water and stirred to separate, remaining solid phase is subjected to solid-liquid separation such as centrifugal solid-liquid separation; (3) second reduction: water is added to the remaining solid phase which is then treated with degradable, particularly biodegradable treatment agent composition; and (4) harmless treatment, if the second reduction results in solid oil content of <5%, remaining solid phase is treated with a (plant-based) recoverable treatment agent composition with stirring at room temperature. This invention has the advantages of simple operation, wide application range, extremely high removal rate of oil content, and the ability to recycle and reuse wastewater. Also, the treated sludge can be used directly for farming purposes.

### BRIEF DESCRIPTION OF THE DRAWINGS

FIG. 1: is a schematic diagram of connections between major systems and equipment in an assembly according to an embodiment of the present invention.

FIG. 2: is a process flow diagram for a treatment process according to an embodiment of the present invention.

### DETAILED DESCRIPTION

Treatment processes, assemblies and agents are described herein for harmlessly treating environmentally harmful materials, in particular oil sludge containing a variety of harmful substances, to separate and recover useful resources such as crude oil from within the oil sludge, and render the resulting sludge harmless.

### Terms

As used herein, and unless stated otherwise, each of the following terms shall have the definition set forth below.

As used herein, and unless otherwise specified, it should be understood that applicant intends to claim “about” each numerical value or range of numerical values as stated and claimed herein, in addition to the specific numerical value or range.

Further, as used herein, “about” in the context of a numerical value or range it means ±10% of the numerical value or range recited or claimed. Alternatively, in the context of a measurable numerical value, the term may also mean the numerical value within the standard error of the analytical method used to measure. By any range disclosed herein, it is meant that all hundredth, tenth and integer unit amounts within the range are specifically disclosed as part of the invention. Accordingly, “about” a recited value specifically includes that recited value.

Further, as used herein, and unless otherwise specified, percentages are given as weight percent.

An objective of the present invention is to address deficiencies in existing technologies as discussed hereinabove, and to provide for means to treat oil sludge to remove harmful materials and recover useful materials therein. In order to achieve said objective, an embodiment according to the present invention provides a method comprising the steps of pretreatment (smashing and separation), first reduction (addition of water, overflow, solid-liquid separation), second reduction, oil content check, crude oil recovery harmless treatment; and final processing, as detailed below:

(1) Pre-treatment and First Reduction: The oil sludge is first crushed, mixed with water, and stirred. After standing and stratification, the upper layer of the oil slick is extracted through an overflow process.

(2) First Reduction and Secondary Reduction: The solid-liquid phase mixture after step (1) is subjected to solid-liquid separation, preferably by centrifugation separation. The solid phase material after separation is subjected to a secondary reduction treatment, water is added to the mixture, a degradable treatment agent is added, and the mixture is stirred until the system is static. Then the upper layer of oil slick is extracted through an overflow process. This will reduce the solid phase oil content to less than 5%.

(3) Oil content check: If oil content of the solid phase material after the secondary reduction treatment above is higher than 5%, then repeat step (2) to reduce the amount of oil until the oil content is less than 5%;

(4) Crude Oil Recovery and Harmless Treatment:
(a) Crude Oil Recovery: For the mixture resulting from steps (2)/(3), the liquid phase obtained is subjected to oil water separation, the oil phase material is transferred into the oil recovery tank, and the water phase material enters a waste water recycling tank so that it can be recycled for reuse; and
(b) Harmless Treatment: The remaining solid phase is then subjected to treatment to make it harmless by adding recoverable treatment agent;

(5) Final Processing: The mixture resulting from step (4) is subjected to centrifugal separation, and the treatment agent is recovered from the liquid phase material by, e.g., sending the liquid phase through distillation. The remaining oil is transferred into the oil recovery tank, and the excess sludge is dried.

In an embodiment, step (1) above specifically comprises: crushing the oil sludge to a size of 5 mm or less, and mixing it with 2-6 times water (w/w) at 50-80° C., slowly stirring for 30-60 min, standing for stratification, then use overflow method to separate and transfer the upper layer of oil slick into the oil recovery tank.

In another embodiment, step (2) above specifically comprises: treating the remaining solid-liquid phase mixture with solid-liquid separation by centrifugation, and recovering the free water through osmosis for reuse, treating the remaining solid phase material with a secondary reduction treatment, adding 2-6 times water (w/w) for mixing, and adding degradable treatment agent 3-5%, stirring at 50-80° C. for 30-60 min, waiting for the system to stand for stratification, using overflow method to separate and transfer the upper layer of oil slick to the oil recovery tank, so that the solid phase oil content is now reduced to less than 5%.

In another embodiment, step (4) above specifically comprises: centrifuging the reduction processed mixture, performing oil-water separation process on the resulting liquid phase material, and transferring the oil phase to the oil recovery tank; the water phase is then entered into the waste water osmosis or diafiltration tank for reuse, and the remaining solid phase material is treated to become environmentally harmless: adding 0.1-10% recoverable treatment agent, and the mixture is stirred well for 30-120 minutes at normal room temperature, and the stirring rate is at 300-600 r/min.

In another embodiment, step (5) above specifically comprises: the post-processing mixture is subjected to centrifugal separation, and the liquid phase material is put into a distillation process to recover the plant based recoverable treatment agent, and the distillation temperature is set at 60-200° C., with a processing time of 60-120 minutes. The recovered plant based recoverable treatment agent can now be recycled and reused. The remaining oil is transferred into the oil recovery tank, and the remaining sludge is to be dried out.

In further embodiment(s), the aforementioned degradable treatment agent comprises a betaine amphoteric surfactant, a tea saponin modified surfactant, a nonionic surfactant, a lower alcohol and additives.

In further embodiment(s), the aforementioned betaine amphoteric surfactant is a long carbon chain hydroxypropyl sulfobetaine surfactant; and/or the prescribed tea saponin modified surfactant agent is an amidated tea saponin nonionic surfactant; and/or the nonionic surfactant comprises a polyether type nonionic surfactant, preferably one or more of nonylphenol polyoxyethylene ether 10/9, alkylphenol polyoxyethylene ether 9/10; and/or the lower alcohol comprise isopropanol, n-butanol, and isobutanol with one or more of the lower carbon chain alcohols having 3 to 6 carbon atoms; and/or the auxiliary agent comprises one or more of the elements including sodium bicarbonate, calcium carbonate, calcium chloride, and magnesium chloride.

In further embodiment(s), the preparation method of the degradable treatment agent is as follows: the above components are mixed and heated to 40-55° C., and the solution can then be dissolved and stirred to become uniform.

In further embodiment(s), the aforementioned recoverable treatment agent is made up of a main agent and a secondary agent, based on the total volume of 100%: the main agent, distillate oil having a boiling range of 110-140 boiling points, accounts for 50-90%; secondary agent, from one or more of the extracted components from the citrus fruit, sunflower seeds, peanuts, tea seeds, olives, lavender, mint and cloves, its components are composed of these extracted components in proportion to the main agent, accounting for 10-50%.

In further embodiment(s), the plant extract components in the secondary agent of the recoverable treatment agent are all extracted and purified from its raw materials by 30-90% ethanol aqueous solution at 30-70° C.

In further embodiment(s), short chain hydrocarbon oils can be generated during the treatment processes, and can be recovered by oil gas condensation absorption recovery system that is connected to the reactor, and discharged to the oil recovery tank, to prevent oil and gas from entering the air, polluting the environment and the security risks that it brings.

In further embodiment(s), the free waste water collected through osmosis during the treatment process as described herein can be directly recycled and reused, thereby greatly reducing water use and associated cost.

In further embodiment(s), the recovered treatment agent as described herein can be reused directly after being recycled, which greatly reduces processing cost.

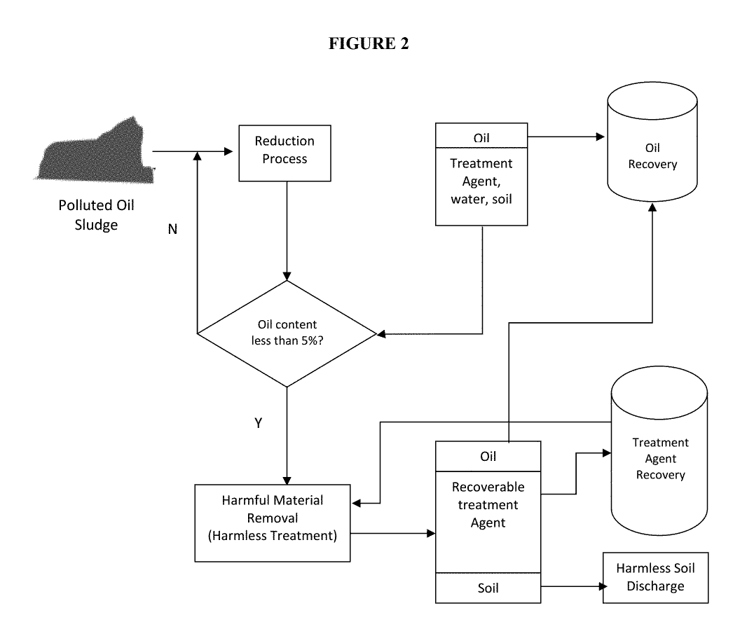

In further embodiment(s), the assembly of systems used in the method as described herein comprises a pretreatment system, a stirring and cleaning system, a centrifugal separation system, an oil and water separation system, a solvent recovery system, an oil and gas recovery system, a petroleum recovery tank and an osmosis water tank, and each system device should be interconnected with stainless steel hose and pump as needed. In an embodiment, one or more of the arrows shown in FIG. 2 represents a pipe or a hose, and can be used with or without a pump to facilitate transfer of materials from one system to another in accordance with the present invention.

In further embodiment(s), the pretreatment system described hereinabove comprises a screw type automatic feeder, a sludge crusher machine, and a sludge screening and separation machine.

In further embodiment(s), the agitation cleaning system described hereinabove comprises or consists of a stirring tank with or without heating capability.

In further embodiment(s), the centrifugal separation system as described hereinabove is a two-phase centrifugal separator machine.

In further embodiment(s), the oil water separation system as described hereinabove is a heated oil-water separator machine.

In further embodiment(s), the solvent recovery system as described hereinabove is a distillation reactor.

In further embodiment(s), the oil and gas recovery system as described hereinabove is a condensation type oil and gas recovery device.

In yet further embodiment(s), the petroleum recovery tank and the osmosis water tank as described hereinabove are horizontal style liquid storage tanks.

### Advantages and Benefits of the Present Invention

This application describes inventions including inventive methods, assembly of systems and equipment, and treatment agents as detailed herein. This invention has the advantages of simple operation, wide application range, high oil removal rate, recycling and reuse of wastewater, and the treated sludge can be directly used for farmland planting. The invention has high processing efficiency, short working time and low processing temperature, can greatly reduce processing energy consumption, can be adapted to various operating environments such as refineries, oil storage warehouses, and oil production plants. It can be used for treatment of sludge found at the bottom of crude oil storage tanks, crude oil transportation pipelines sludge, refinery sludge, oil production plant sludge and other types of oil based sludges. This invention can be used in a wide range of applications.

It has been demonstrated in practice that the petroleum hydrocarbon content of the residual sludge after treatment according to the invention as described herein is as low as 300-2000 mg/kg, which can be used directly for planting in farmlands. Moreover, it has been used for planting strawberries, and the growth condition of strawberries was determined to be good.

The combination of any embodiment or feature mentioned herein with one or more of any of the other separately mentioned embodiment(s) or feature(s) is contemplated to be within the scope of the instant invention. Any feature disclosed with respect to the processing method described herein is intended to be applicable to the assembly as described herein, and vice versa, without departing from the spirit of the present invention. Further, any feature disclosed with respect to the treatment agents as described herein is intended to be applicable to the assembly and/or treatment method as described herein, and vice versa, without departing from the spirit of the present invention.

In the same vein, the specific embodiments and examples described herein are illustrative, and many variations can be introduced on these embodiments and examples without departing from the spirit of the disclosure or from the scope of the appended claims. Elements and/or features of different illustrative embodiments and/or examples may be combined with each other and/or substituted for each other within the scope of this disclosure and appended claims.

Finally, non-limiting details are described in the following Examples and Exemplary Implantations section which is set forth to aid in an understanding of the subject matter but is not intended to, and should not be construed to, limit in any way the claims which follow thereafter.

### EXEMPLARY IMPLEMENTATIONS

The inventive method, assembly and treatment agent will be further explained and illustrated below, with reference to the attached drawings, and specific implementation examples.

### Example 1

Tank bottom sludge of an oil depot is treated in this example. The sludge selected is a viscous black substance with certain fluidity. Crude oil and water envelop the sediment. The material system is uniform. The oil content of the sludge is 58.67%, and the water content is 20.13%. The rest of the content is sediment.

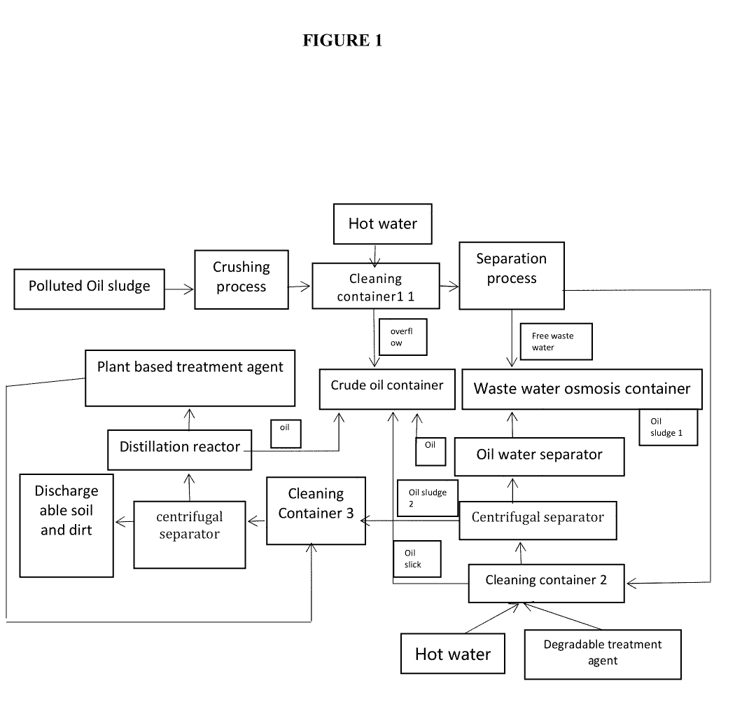

A treatment method per the present invention is used, which comprise the steps as shown in FIG. 2 (Basic Flow Chart), and use basic assembly of systems and equipment as shown in FIG. 1. More specifically, the treatment is discussed in more detail below.

(1) Pick out the larger stones, plastic trash, tree branches, and other waste materials from the oil sludge sample. Using a screw feeder, the sludge is pushed into a mixing and cleaning tank filled with a certain amount of water in advance at a certain propulsion speed. The ratio of material to liquid is 1:3, stirred at 600 r/min and the mixture is heated to 70° C. After 60 minutes, stirring is stopped and the materials are allowed to stand for 15 minutes. After the stratification, the oil is surfaced as slick and discharged by overflow to the oil recovery tank, and the remainder of the material is then pumped into a spiral solid-liquid separator by a sludge pump to perform solid-liquid separation, and the resulting free wastewater is discharged into the wastewater recycling tank for recycle and reuse.

(2) The remaining solids separated out in step (1) are injected into the stirring and cleaning tank for the secondary reduction processing. Water (3 times the total amount of solids) is added, heated to 80° C. while stirring, and the degradable treatment agent is added at the same time, so that the final concentration reaches 0.5%. After the mixture is stirred for 30 min at stable temperature, the mixture is allowed to stand for stratification, and the upper layer slick is discharged to the oil recovery tank. The remainder is pumped into the spiral solid-liquid separator by the sludge pump to perform solid-liquid separation operation. The resulting free wastewater is discharged into the wastewater recycling tank for recycle and reuse.

The composition of the degradable treatment agent is (by weight) is as follows: 45 parts of hydroxypropyl sulfobetaine amphoteric surfactant, 15 parts of tea saponin modified surfactant, 20 parts of nonyl phenol polyoxyethylene ether 10, 16 parts of n butanol, 3.0 parts of sodium bicarbonate, and 1.0 part of calcium chloride. Heat the ingredients separately to 45° C. and stir well.

(3) The remaining solids separated out in step (2) are injected into the stirring and cleaning tank for the second time to reduce the amount of solids. Recoverable treatment agent is added at 1% of the total amount of the solids. After stirring at room temperature for 30 minutes, the sludge is discharged through a sludge pump into a spiral solid-liquid separator for solid-liquid separation. The resulting liquid layer enters the distillation reactor and is reacted for 120 minutes at 30-100° C. The recovered recyclable agent is discharged into the recoverable agent storage tank for recycling. The remaining oil is discharged into a petroleum recovery tank, and the solids obtained by solid-liquid separation are dried.

The recoverable treatment agent described above is comprised of 50 parts of fractionated oil having a boiling point of 120° C., 15 parts of sunflower seed extract, 10 parts of peanut extract, 10 parts of olive extract, 2 parts of lavender extract, and 5 parts of tea seed extract, 0.5 part of peppermint extract, 0.1 part of alpha pinene, 0.2 part of myrcene, and 0.2 part of limonene.

After the above treatment, a total of 90% of the crude oil was recovered, 91% of the treatment agent was recovered, and no sewage water was discharged. The post-processing soil was tested to have 394 mg/kg of petroleum hydrocarbons.

### Example 2

Oil field oil sludge is used in this example. The sludge selected is a viscous black substance with little mobility. The sludge contains 67.2% of oil, 10% of water, and the rest is silt.

A treatment method per the present invention is used, which comprise the steps as shown in FIG. 2 (Basic Flow Chart), and use basic assembly of systems and equipment as shown in FIG. 1. More specifically, the treatment is discussed in more detail below.

(1) Pick out the larger stones, plastic trash, tree branches, and other waste materials from the oil sludge sample. Using a screw feeder, the sludge is pushed into a mixing and cleaning tank filled with a certain amount of water in advance at a certain propulsion speed. The ratio of material to liquid is 1:1, stirred at 600 r/min and the mixture is heated to 70° C. After 60 minutes, the stirring is stopped and the materials are allowed to stand for 15 minutes. After stratification, the oil is surfaced as slick and discharged by overflow to the oil recovery tank, and the remainder of the material is then pumped into a spiral solid-liquid separator by a sludge pump to perform solid-liquid separation. The resulting free wastewater is discharged into the wastewater recycling tank for recycle and reuse.

(2) The remaining solids separated out in step (1) are injected into the stirring and cleaning tank for the secondary reduction processing. Water (2 times the total amount of solids) is added heated to 70° C. while stirring, and the degradable treatment agent is added at the same time, so that the final concentration reaches 0.2%, after the mixture is stirred for 30 min at stable temperature, the mixture is allowed to stand for stratification, and the upper layer slick is discharged to the petroleum recovery tank. The remainder is pumped into the spiral solid-liquid separator by the sludge pump to perform solid-liquid separation operation. The resulting free wastewater is discharged into the wastewater recycling tank for recycle and reuse.

The composition of the degradable treatment agent is (by weight): 60 parts of hydroxypropyl sulfobetaine amphoteric surfactant, 5 parts of tea saponin modified surfactant, 12 parts of alkyl phenol ethoxylate 9, 20 parts of isobutanol, 3 parts of sodium carbonate. Heat the ingredients separately to 45° C. and stir well.

(3) The remaining solids separated out in step (2) are injected into the stirring and cleaning tank for the second time to reduce the amount of the solids, add recoverable treatment agent at 2% of the total amount of the solid. After stirring at room temperature for 30 minutes, the sludge is discharged through a sludge pump into a spiral solid-liquid separator for solid-liquid separation. The resulting liquid layer enters the distillation reactor and is reacted for 120 minutes at 30-100° C. The recovered recyclable agent is discharged into the recoverable agent storage tank for recycling. The remaining oil is discharged into a petroleum recovery tank, and the solids obtained by solid-liquid separation are dried.

The recoverable treatment agent described above comprises 40 parts of fractionated oil having a boiling point of 120° C., 10 parts of sunflower seed extract, 10 parts of peanut extract, 10 parts of olive extract, 8 parts of tea seed extract, 0.1 part of alpha pinene, 0.2 part of myrcene, 0.2 part of limonene, 0.5 parts of behenyl alcohol and 0.5 parts of farnesene.

After the above three step treatment, a total of 93% of the crude oil was recovered, 90% of the treatment agent was recovered, and no sewage water was discharged. The post-processing soil was tested to have 700 mg/kg of petroleum hydrocarbons. Further, strawberries grown in the post-processing soil grew well, and small insects such as snails could be found in the soil.

### Example 3

Oil sludge of an oil refinery is used in this example. The sludge selected is a viscous black substance with no mobility, fine and uniform particle size, with no impurities. The sludge contains 40.2% of oil, 50% of water, and the rest is silt.

A treatment method per the present invention is used, which comprise the steps as shown in FIG. 2 (Basic Flow Chart), and use basic assembly of systems and equipment as shown in FIG. 1. More specifically, the treatment is discussed in more detail below.

(1) Using a screw feeder, the sludge is pushed into a mixing and cleaning tank filled with a certain amount of water in advance at a certain propulsion speed. The ratio of material to liquid is 1:1.5, stirred at 300 r/min and the mixture is heated to 70° C. After 60 minutes, the stirring is stopped and the materials are allowed to stand for 60 minutes. After the stratification, the oil is surfaced as slick and discharged by overflow to the oil recovery tank, and the remainder material is then pumped into a spiral solid-liquid separator by a sludge pump to perform solid-liquid separation, and the resulting free wastewater is discharged into the wastewater recycling tank for recycle and reuse.

(2) The remaining solids separated out in step (1) are injected into the stirring and cleaning tank for the secondary reduction processing. Water (4 times the total amount of solids) is added as heated to 75° C. while stirring, and the degradable treatment agent is added at the same time, so that the final concentration reaches 0.33%. After the mixture is stirred for 30 min at stable temperature, the mixture is allowed to stand for stratification, and the upper layer slick is discharged to the petroleum recovery tank. The remainder is pumped into the spiral solid-liquid separator by the sludge pump to perform solid-liquid separation operation. The resulting free wastewater is discharged into the wastewater recycling tank for recycle and reuse.

The composition of the degradable treatment agent is (by weight): 38 parts of betaine amphoteric surfactant, 32 parts of tea saponin modified surfactant, 8 parts of octylphenol polyoxyethylene ether 10, 10 parts of alkylphenol polyoxyethylene ether 10, 10 parts of isobutanol, 2 parts of sodium bicarbonate. Heat the ingredients separately to 50° C. and stir well.

(3) The remaining solids separated out in step (2) are injected into the stirring and cleaning tank for the second time to reduce the amount of solids. Recoverable treatment agent is added at 5% of the total amount of the solid. After stirring at room temperature for 60 minutes, the sludge is discharged through a sludge pump into a spiral solid-liquid separator for solid-liquid separation. The resulting liquid layer enters the distillation reactor and is reacted for 200 minutes at 30-110° C. The recovered recyclable agent is discharged into the recoverable agent storage tank for recycling. The remaining oil is discharged into a petroleum recovery tank, and the solids obtained by solid-liquid separation are dried.

The recoverable treatment agent described above comprises 45 parts of fractionated oil having a boiling point of 120° C., 11 parts of sunflower seed extract, 12 parts of peanut extract, 12 parts of olive extract, and 8 parts of tea seed extract, 2 parts of lavender extract, 0.8 part of alpha pinene, 0.2 part of myrcene, 0.2 part of limonene, 0.5 parts of red perphenine and 0.5 parts of farnesene.

After the above 3 step treatment, a total of 95% of the crude oil was recovered, 92% of the treatment agent was recovered, and no sewage water was discharged. The post processing soil was tested to have 1200 mg/kg of petroleum hydrocarbons.

From Examples 1 to 3 above, it can be seen that use of this invention to treat oil containing sludge and dirt can ultimately meet the standards for use as farmland soil, and that this invention can effectively remove oil sludge.

1. A method for processing an oil sludge sample into an environmentally harmless resource, comprising the following steps:
(1) crushing the oil sludge, mixing with water, and then stirring, and after standing and stratification, extracting the upper layer of oil slick through overflow process;
(2) subjecting the solid-liquid phase obtained from step (1) to solid-liquid separation by centrifugation, subjecting the solid phase after separation to a second reduction treatment, adding water to the mixture, adding a degradable treatment agent, and stirring the mixture stirred until the system is static, and extracting the upper oil slick through overflow, so as to reduce the solid phase oil content to less than 5 percent;
(3) confirming that the oil content of the solid phase obtained from step (2) is not higher than 5 percent, and if so, repeating step (2) to reduce the amount of oil until the content is less than 5 percent;
(4) subjecting the liquid phase in the mixture resulting from step (2) or (3) to oil water separation, transferring the oil phase into the oil recovery tank, and sending the water phase to enter the wastewater recycling tank for recycle and reuse, and then subjecting the remaining solid phase to treatment to make it harmless by adding recoverable treatment agent;
(5) subjecting the mixture resulting from step (4) to centrifugal separation, and sending the liquid phase through distillation to recover the treatment agent, transferring the remaining oil into the oil recovery tank, and drying the excess sludge.

2. The method according to claim 1, wherein the degradable treatment agent comprises:
a betaine amphoteric surfactant, a tea saponin modified surfactant, a nonionic surfactant, a lower alcohol and additives.

3. The method according to claim 2, wherein:
the betaine amphoteric surfactant is a long carbon chain hydroxypropyl sulfobetaine surfactant, and/or
the tea saponin modified surfactant agent is an amidated tea saponin nonionic surfactant, and/or
the nonionic surfactant comprises a polyether nonionic surfactant, and/or
the lower alcohol includes isopropanol, n butanol, and isobutanol with one or more of the lower carbon chain alcohols having 3 to 6 carbon atoms, and/or
the auxiliary agent comprises one or more materials selected form the list consisting of sodium bicarbonate, calcium carbonate, calcium chloride and magnesium chloride.

4. The method according to claim 1, wherein the recoverable treatment agent comprises:
a main agent and a secondary agent, based on the total volume of 100%, a main agent being a distillate oil having a boiling range of 110-140 boiling points, accounting for about 50-90%; and
a secondary agent being selected from one or more of the group consisting of extracted components from the citrus fruit, sunflower seeds, peanuts, tea seeds, olives, lavender, mint and cloves, accounting for about 10-50%.

5. The method according to claim 1, wherein step (1) comprises:
crushing the oil sludge to a size of 5 mm or less, and
mix with 2 to 6 times water (w/w) at 50-80° C.,
slowly stirring for 30-60 min,
standing for stratification,
then use overflow method to separate and transfer the upper layer of oil slick into the oil recovery tank.

6. The method according to claim 1, wherein step (2) comprises:
treating the remaining solid-liquid phase mixture with solid-liquid separation by centrifugation,
recovering the free water through osmosis for reuse,
treat the remaining solid phase material with a secondary reduction treatment, adding 2-6 times water (w/w) for mixing, and adding degradable treatment agent 0.3-0.5%, stirring at 50-80° C. for 30-60 min,
waiting for the system to stand for stratification,
using overflow method to separate, and
transfer the upper layer of oil slick to the oil recovery tank, so that the solid phase oil content is reduced to less than 5%.

7. The method according to claim 1, wherein step (4) comprises:
centrifuging the reduction processed mixture, performing oil-water separation process on the resulting liquid phase material, and transfer the oil phase to the oil recovery tank, the water phase is then entered into the wastewater diafiltrating tank for reuse, and the remaining solid phase is treated to become environmentally harmless by adding 0.1-10% recoverable treatment agent, and the mixture is stirred well for 30-120 minutes at normal room temperature, and the stirring rate is at 300-600 r/min.

8. The method according to claim 1, wherein step (5) comprises:
the post processing mixture is subjected to centrifugal separation, and the liquid phase material is then put into a distillation process to recover the recoverable treatment agent, and the distillation temperature is set at 60-200° C., with an overall processing time of 60-120 minutes, the recovered recoverable treatment agent can now be recycled and reused, and the remaining oil content is transferred into the oil recovery tank, and the remaining sludge material is to be dried out.

9. The method according to claim 1, using an assembly of systems which includes a pretreatment system, a stirring and cleaning system, a centrifugal separation system, an oil and water separation system, a solvent recovery system, an oil and gas recovery system, an oil recovery tank and an osmosis water tank.

10. An assembly for treating oil sludge comprising:
a pretreatment system, a stirring and cleaning system, a centrifugal separation system, an oil and water separation system, a solvent recovery system, an oil and gas recovery system, a solvent recovery system, an oil recovery tank, an osmosis water tank, and connections and pumps interconnecting one of more of the systems.

11. A treatment agent for treating oil sludge;
(i) wherein the treatment agent is degradable, and comprises a betaine amphoteric surfactant, a tea saponin modified surfactant, a nonionic surfactant, a lower alcohol and additives; or
(ii) wherein the treatment agent is recoverable, and comprises a main agent and a secondary agent,
wherein, based on the total volume of 100%:
about 50-90% of the main agent comprises a distillate oil having a boiling range of 110-140 boiling points; and
about 10-50% of secondary agent comprising one or more of the group consisting of extracted components from the citrus fruit, sunflower seeds, peanuts, tea seeds, olives, lavender, mint and cloves.

12. (canceled)
